(19) United States
(12) Patent Application Publication
(10) Pub. No.: US 2026/0091730 A1
(43) Pub. Date: Apr. 2, 2026

(54) Rearview Mirror Adjustment System

(71) Applicant: Justin Jones, Malvern, AR (US)

(72) Inventor: Justin Jones, Malvern, AR (US)

(21) Appl. No.: 18/903,329

(22) Filed: Oct. 1, 2024

(51) Int. Cl. B60R 1/04

(52) U.S. Cl. CPC B60R 1/04

(57) ABSTRACT

The Rear View Mirror system is the only product of its kind that enables users to fine-tune their mirror's angle via an easy to access control button, ensuring that their field of vision remains unobstructed, optimizing the use of a rear view reflection that complements the side view during drives. A vehicle mirror comprising a mount for a mirror positioned on an inside surface of a front windshield and comprising at least one electric motor configured to adjust the mount and therefore adjust the mirror. The disclosure also includes at least one control button configured in a one to one deterministic control of the at least one electric motor via an electromagnetic connection there between, wherein the at least one control button is positioned inside the vehicle accessible to a driver seated in the vehicle.

### BACKGROUND

Achieving the ideal rear view mirror position often varies in preparation for a while one is driving; thus, the constant change can be a tedious process. Currently, manual modifications are the only option for positioning a rear view mirror versus the support of automatic buttons that permit adjustments to side view mirrors. There have been no products available as original equipment or as an aftermarket to address this problem.

An apparatus that simplifies the need to constantly change your rear view mirrors manually is not being met by any known device or system at present. There have been no products available as original equipment or as an aftermarket to address this problem either.

### SUMMARY OF THE INVENTION

The main purpose the Rearview Mirror Adjustment System is to provide users with an effective, automated method of adjusting the rear view mirror in an automobile.

A vehicle mirror comprising a mount for a mirror positioned on an inside surface of a front windshield and comprising at least one electric motor configured to adjust the mount and therefore adjust the mirror. The disclosure also includes at least one control button configured in a one to one deterministic control of the at least one electric motor via an electromagnetic connection there between, wherein the at least one control button is positioned inside the vehicle accessible to a driver seated in the vehicle.

### BRIEF DESCRIPTION OF THE DRAWINGS

FIG. 1 is a front perspective view of the Rearview Mirror Adjustment System in accordance with an embodiment of the present disclosure.

FIG. 2 is a schematic representation of the modes of operation of the Rearview Mirror Adjustment in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

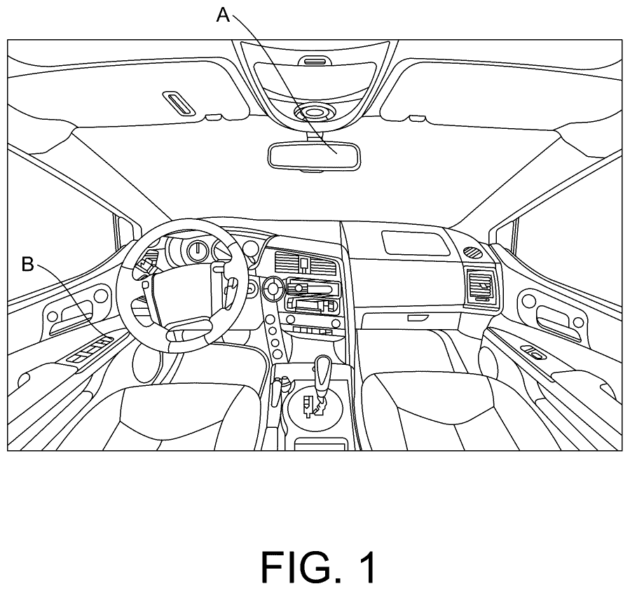

FIG. 1 is a front perspective view of the Rearview Mirror Adjustment System showing: automated rear-view mirror referenced as A, rear-view mirror control button referenced as B, in accordance with an embodiment of the present disclosure. A vehicle mirror comprising a mount for a mirror positioned on an inside surface of a front windshield and comprising at least one electric motor configured to adjust the mount and therefore adjust the mirror. The disclosure also includes at least one control button configured in a one to one deterministic control of the at least one electric motor via an electromagnetic connection there between, wherein the at least one control button is positioned inside the vehicle accessible to a driver seated in the vehicle.

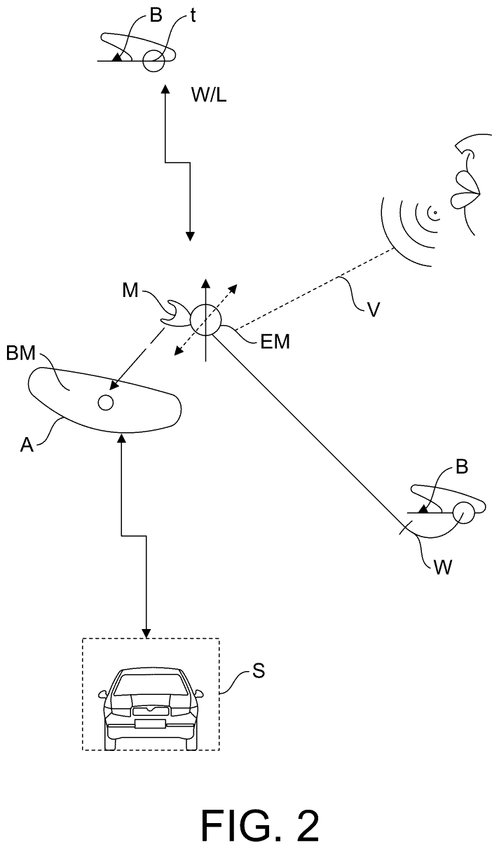

FIG. 2 is a schematic representation of the modes of operation of the Rearview Mirror Adjustment in accordance with an embodiment of the present disclosure. The representation includes the mirror A, the button B, the mount M, the electric motor EM, the rearward car sensor S for a virtual control button, the wired button W, the wireless W/L button and transceiver t and the voice V command control for a virtual control button embodiments.

The present disclosed the Rearview Mirror Adjustment System, also known as “The Rear View Mirror Control”, offers a modern adaptation that eliminates the need to fumble with manual adjustments to fix the mirror while driving and therefore allows for an improved operational experience, at all times. The Rear View Mirror Control introduces a novel automated rear view mirror that works in complement with a control button allowing users to effortlessly position the mirror to their exact specifications, regardless of their operator seating position within the car. By ensuring that the mirror is correctly adjusted and/or controlled via a button feature, this innovative device significantly reduces the risk of crashes caused by blind spots, limited visibility, and decreases the safety risks for drivers, considering their attention can be focused on the road rather than attempting to perfect a mirror manually during automobile operation. This innovative, top-quality product eliminated the challenges of traditional mirror adjustments and embraces the simplicity of effortless control. As a result, the Rear View Mirror Control may benefit drivers around the globe and therefore may prove to be essential in the automotive industry.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is to be claimed is:

1. A vehicle mirror comprising: a mount for a mirror positioned on an inside surface of a front windshield and comprising at least one electric motor configured to adjust the mount and therefore adjust the mirror; and
at least one control button configured in a one to one deterministic control of the at least one electric motor via an electromagnetic connection there between,
wherein the at least one control button is positioned inside the vehicle accessible to
a driver seated in the vehicle.

2. The vehicle mirror of claim 1, wherein the electromagnetic connection comprises at least one wire in a circuit comprising the at least one electric motor and the at least one control button.

3. The vehicle mirror of claim 1, wherein the at least one electric motor comprises three electric motors for each of a tilt up/down, tilt left/right and daylight/moonlight motions.

4. The vehicle mirror of claim 1, wherein the mount comprises a ball joint attached to a backside of the mirror.

5. The vehicle mirror of claim 1, wherein the mount comprises two attachments for a tilt up/down, and move left/right via a backside of the mirror.

6. The vehicle mirror of claim 1, wherein the electromagnetic connection comprises a wireless transceiver link of the at least one electric motor and the at least one control button.

7. The vehicle mirror of claim 1, wherein the control button comprises two degrees of a tilt movement and a side to side movement of the mount and of the mirror.

8. The vehicle mirror of claim 1, wherein the at least one control button is positioned on a dash of the vehicle.

9. The vehicle mirror of claim 1, wherein the at least one control button is positioned on a driver door interior of the vehicle.

10. The vehicle mirror of claim 1, wherein the at least one control button is positioned on a steering wheel of the vehicle.

11. The vehicle mirror of claim 1, wherein the at least one control button is virtual and accessible via a voice command from the driver of the vehicle.

12. The vehicle mirror of claim 1, wherein a power for the at least one electric motor comes from a solar chargeable battery adjacent the mount.

13. The vehicle mirror of claim 1, wherein a power for the at least one electric motor is delivered through the electromagnetic connection.

14. The vehicle mirror of claim 1, wherein the control button is virtual and automatic based on another car position sensed rearward relative to the vehicle.

15. The vehicle mirror of claim 1, wherein the control button is virtual and based on another car position sensed rearward relative to the vehicle with a manual/voice override.
